(19) United States
(12) Patent Application Publication
(10) Pub. No.: US 2008/0284799 A1
(43) Pub. Date: Nov. 20, 2008

(54) Discontinous Zoom

(75) Inventors: Gerard Hollemans, Eindhoven (NL); Huib V. Kleinhout, Waalre (NL); Vincent P. Buil, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,919

(22) PCT Filed: Jun. 24, 2005
(86) PCT No.: PCT/IB2005/052108

§ 371 Date: Dec. 19, 2006

Related U.S. Application Data
(60) Provisional application No. 60/583,968, filed on Jun. 29, 2004.
(60) Provisional application No. 60/646,087, filed on Jan. 21, 2005.

(51) Int. Cl. G09G 5/00

(52) U.S. Cl. 345/660

(57) ABSTRACT

In a method and apparatus for zooming on a display device, instead of zooming just on the pixels in the display, zooming is effected on discernable objects comprising pixel in the displayed image. Initially, spaces between the discernable objects is reduced, and then the discernable objects are increased in size until the objects reach a minimum surface area, which is the minimum size, based on the size and resolution of the display, recognizable by a user. Zooming is then suspended until the user selects one of the objects. Zooming is then allowed to continue on only the selected object until the maximum zooming factor is reached.

### FIELD OF THE INVENTION

The subject invention relates to zooming, and more particularly, to zooming an image signal containing discernable objects on a display device.

### DESCRIPTION OF THE RELATED ART

Zooming is usually applied to enable a user to more easily see the details of items that are presented on a display screen of a display device. It is known from psychology that visual objects in close proximity of the object of attention can be ignored by the brain of a user, but do affect the processing of the object of attention negatively, i.e., they can be partly ignored, but remain distracting. Most zooming functions do not take this into consideration, and zoom continuously in such a way that any displayed pixel is zoomed in. This leads to enlargement of portions of the image having irrelevant information, e.g., spaces between objects on the display screen as well as the objects themselves.

However, in some video images, objects in the image can be discerned but the prior art zooming methods ignore these discernable objects and proceed to zoom on all of the pixels in the display.

It is an object of the invention, when presented with an image signal having discernable objects, to only zoom on the pixels in the discernable objects.

This object is achieved in a method for zooming a video image on a display device, said video image being discernable in a plurality of objects, and said display device having a minimum surface area for objects, said method comprising the steps of displaying a video image on a display screen of a display device, said video image having discernable objects each comprising a plurality of pixels; discerning the objects in said video image; zooming said video image by reducing the area of any spaces in the video image not included in said discernable objects, and increasing the sizes of said discerned objects until said discerned objects have said minimum surface area; discontinuing said zooming until a user selects one of said discerned objects; detecting the user's selection out of said discerned objects; and zooming only on the selected discerned object.

The above object is also achieved in an apparatus for zooming a video image on a display device, said video image being discernable in a plurality of objects, and said display device having a minimum surface area for objects, said apparatus comprising a video image processor for displaying a video image on a display screen of a display device, said video image having discernable objects each comprising a plurality of pixels; means for discerning the objects in said video image; means for zooming said video image by reducing the area of any spaces in the video image not included in said discernable objects, and increasing the sizes of said discerned objects until said discerned objects have said minimum surface area, and for generating a status signal; means for discontinuing said zooming upon receipt of said status signal; means for detecting the user's selection out of said discerned objects; and means for continuing zooming only on the selected discerned object.

Applicants have found that instead of zooming on all displayed pixels, zooming may be applied to only the pixels in visual objects, such as buttons, as is done in some applications. So far, this has been used to enlarge elements of user interfaces that are then more easily accessible for users to operate on. Applicants propose to apply the same principle to displayed text that is encoded in XML, or a derivative, such as HTML.

XML, and HTML, pages can be structured such that objects of text, e.g., the main body, an advertisement banner, the navigation section, can be identified. Even if these pages are not purposely structured so that these elements can be recognized, it is possible to do so with simple analysis of the document, e.g., extracting the tables from an HTML page.

Once the page can be divided into objects as well as pixels (of the page and of the objects), an input of the user on the zoom factor (i.e., a user request the zoom in or out) may now be translated into changes in what is being displayed. When the whole page fits the screen such that the individual objects are meaningfully selectable, i.e., the user is able to see what he/she is selecting, the user is then able to select the desired object, and zooming is continued based on the selected object.

Ordinarily, zooming is usually provided since the screen is too small for a user to operate on the individual elements without zooming, while an overview of the image is meaningful to determine a general direction of panning and/or zooming. For these cases, the discontinuous zooming of the subject invention is helpful. The zooming first works on the whole page up to a point where the user can select an object to zoom in, at which point zooming stops. Once the user has selected an object of interest, other objects are left out from the display and the zooming works on the selected object.

The zoom factor must be determined at which to require the user to make a selection. Since this depends on the size of the page and the absolute and relative sizes of the objects on the page, the zoom factor at which the user has to choose an object cannot be a fixed factor for all pages. For a given screen size, the average minimum surface area can be derived for an object to be recognized. Thus, in the zooming processing, all of the “white space”, i.e., non-object space, is reduced, then the zooming process continues by zooming the objects until all objects that are being displayed have the minimum surface area as determined. At this point, zooming is suspended pending the user selecting on object to zoom in on.

In an embodiment of the method and apparatus of the invention, the increasing in size of each of the discerned objects stops when the size of the relevant discerned object reaches said minimum surface area. If the sizes of the displayed objects are too different, one object could fill the screen almost completely before another object has the minimum required surface area. As such, the subject invention stops increasing the size of an object when that object reaches the minimum surface area. This allows sufficient space for other smaller objects to be zoomed in order to reach the minimum surface area.

In another embodiment of the method and apparatus of the invention, the object selected by the user is highlighted. This provides a feedback to the user as to which object has been selected.

With the above and additional objects and advantages in mind as will hereinafter appear, the invention will be described with reference to the accompanying drawings, in which:

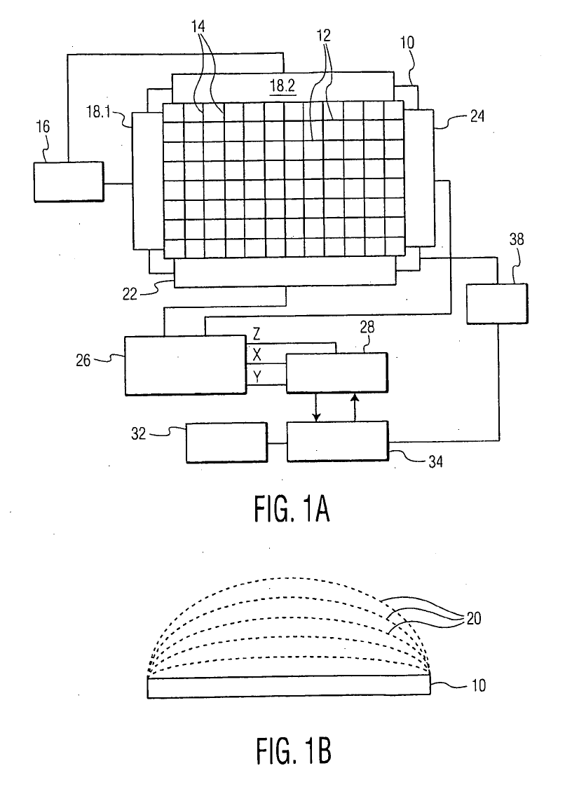

FIG. 1A is a block diagram of a display device having a capacitive sensor array incorporated therein;

FIG. 1B is a diagram showing the detection lines of the sensor array of FIG. 1A;

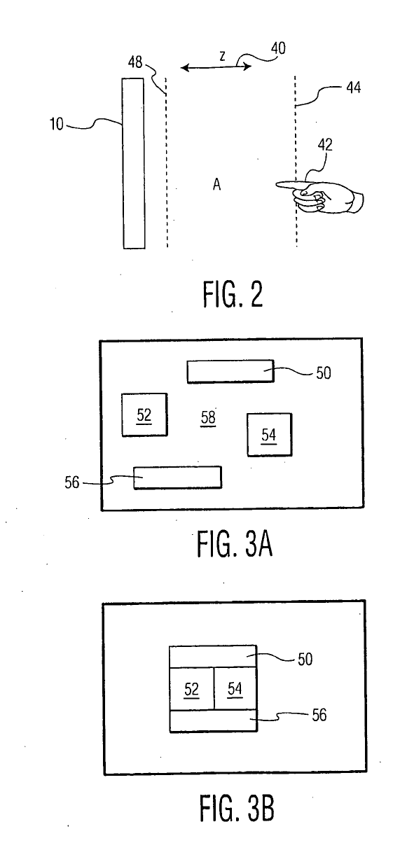

FIG. 2 is a diagram showing the detection zone extending from the surface of the display screen;

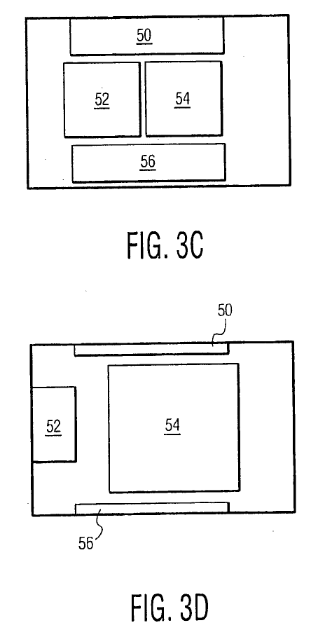

FIGS. 3A-3D show various stages of zooming of objects on the display screen of the display device;

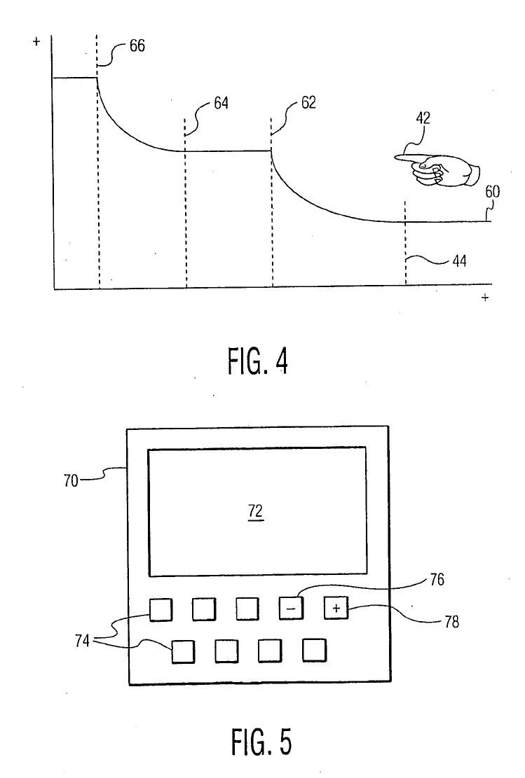

FIG. 4 shows a graph of the zoom factor versus the distance from the display screen; and

FIG. 5 shows an illustration of a portable video device in which zooming is controlled by keys.

The subject invention makes use of a 3-D display, that is, a display that is capable of detecting the horizontal and vertical position of a pointer, stylus or a user's finger with respect to the surface of the display screen, as well as the distance of the pointer, stylus or user's finger from the surface of the display screen. There are various known types of 3-D displays using, for example, infrared sensing, capacitance sensing, etc. One type of a 3-D display is disclosed in U.S. Patent Application Publication No. US2002/0000977 A1, which is incorporated herein by reference.

As shown in FIG. 1A, a display screen 10 has superimposed thereon a grid of electrically conductive transparent conductors in which the horizontal conductors 12 are electrically isolated from the vertical conductors 14. A voltage source 16 connected to connection blocks 18.1 and 18.2 applies a voltage differential across the horizontal and vertical conductors 12 and 14. This arrangement develops a detection field 20 extending away from the surface of the display screen 10 as shown in FIG. 1B, with the horizontal and vertical conductors 12 and 14 acting as plates of a capacitor.

When, for example, a user's finger enters the detection field 20, the capacitance between the conductors 12 and 14 is affected and is detected by X-axis detector 22, connected to the vertical conductors 14 and the Y-axis detector 24, connected to the horizontal conductors 12. A detector signal processor 26 receives the output signals from the X and Y detectors 22 and 24 and generates X, Y coordinate signals and a Z distance signal. The X and Y coordinate signals and the Z distance signal are applied to a zoom controller 28.

In addition, as shown in FIG. 1A, an image signal source 32 supplies an image signal to an image signal processor 34, which also receives a zoom control signal from the zoom controller 28. The output signals from the image signal processor 34 is supplied to a display controller 38 which then applies video signals to the display screen 10.

As shown in FIG. 2, the zoom controller 28 establishes a zone A extending in the Z direction (dual-headed arrow 40) from the surface of the display screen 10. The zone A denotes a zone in which, when the user's finger 42 passes a threshold distance 44, the user's finger 42 is detected and zooming is initiated.

FIG. 3A shows a display screen 10 in which a video image contains discernable objects 50, 52, 54 and 56 of varying sizes separated by spaces 58. These objects are detected in the image signal processor 34. Once the zooming process commences (e.g., the user moves his/her finger 42 towards the display screen 10 past the threshold 44), the image signal processor 34, in response to zoom control signals from the zoom controller, reduces the size of the spaces 58 between the objects 50-56, as shown in FIG. 3B. Then, the image signal processor 34 increases the sizes (zooms) the objects 50-56 until they reach a minimum surface area (see FIG. 3C). This minimum surface area is predetermined by the size and resolution of the display screen 10 and represents a minimum size of an object at which the object may be discerned by a viewer. At this point, the image signal processor 34 signals the zoom controller 28 and zooming process is suspended (i.e., further movement of the user's finger toward the display screen 10 is ignored) until the user selects one of the objects. With the 3-D touch display, this may involve the user moving his/her finger in the X/Y direction and selecting the object by, for example, slightly retracting his/her finger. As shown in FIG. 3C, the image signal processor 34 may highlight the selected object 54. At this point, the zooming process is allowed to continue with the selected object 54 increasing in size while the unselected objects 50, 52 and 56 drop off the screen.

FIG. 4 shows a graph illustrating the zooming process in which the X axis is the distance from the display screen 10 and the Y axis is the zoom factor. Until the user's finger 42 passes the threshold 44, the zoom factor curve 60 assumes a predetermined minimum value. Once the user's finger 42 passes the threshold 44, zooming factor curve 60 begins to increase with the reduction in the spaces followed by the increase of the surface areas of the objects. At distance 62, when all of the objects have reached the minimum surface-area, changes in the zooming factor curve 60 is suspended while allowing the user to select one of the objects. At that point as indicated by distance 64, zooming continues on the selected object up to the maximum zoom factor at distance 66.

In the case where the objects 50-56 greatly vary in size, during the process of increasing the size of the objects, the larger object(s) may reach and surpass the minimum surface area well before the smaller object(s). In order to prevent these larger objects from dominating the display screen 10 prior to the smaller objects attaining the minimum surface area, as soon as each object achieves the minimum surface area, zooming on that particular object is suspended while zooming continues on the smaller object(s).

While the subject invention has been described as embodied in a 3-D touch display device, this is not necessarily the case. A portable display device 70 is shown in FIG. 5 and has a display screen 72. The portable display device 70 has a plurality of keys 74 enabling a user to control the various functions. Among the keys 74 are a “−” key 76 and a “+” key 78 which may be used to control zooming. In particular, zooming commences when the user presses and holds down the “+” key 78. Again, first the spaces are reduced and then the surface areas of the objects are increased until the objects have the minimum surface area. Zooming is then suspended even though the user may continue to press the “+” key 78. Using the keys 74, the user selects one of the objects, and then when the user presses and holds down the “+” key, zooming is continued on the selected object until the zooming reaches the maximum zooming factor.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A method for zooming a video image on a display device, said video image being discernable in a plurality of objects, and said display device having a minimum surface area for objects, said method comprising the steps of:
displaying (32, 34, 38) a video image on a display screen (10) of a display device, said video image having discernable objects (50, 52, 54, 56) each comprising a plurality of pixels;
discerning (34) the objects in said video image;
zooming (28, 34) said video image by reducing the area of any spaces (58) in the video image not included in said discernable objects (50, 52, 54, 56), and increasing the sizes of said discerned objects (50, 52, 54, 56) until said discerned objects have said minimum surface area;
discontinuing said zooming until a user selects one (54) of said discerned objects (50, 52, 54, 56);
detecting the user's selection (54) out of said discerned objects; and
zooming (28, 34) only on the selected discerned object (54).

2. The method as claimed in claim 1, wherein after said detecting step, said method further comprises the step of:
removing, from the video image, the discerned objects (50, 52, 56) other than said selected discerned object (54).

3. The method as claimed in claim 1, wherein in said first zooming (28, 34) step, the increasing in size of each of the discerned objects (50, 52, 54, 56) stops when the size of the relevant discerned object reaches said minimum surface area.

4. The method as claimed in claim 1, wherein said video image is encoded in XML or HTML object based format.

5. The method as claimed in claim 1, wherein said detecting step comprises highlighting a perimeter of said selected discerned object (54).

6. The method as claimed in claim 1, wherein said display device (10) is a 3-D virtual touch display device, and zooming is effected by detecting (22, 24, 26) the position and distance (Z) of a user's finger (42) on and from a display surface (10) of the display device.

7. An apparatus for zooming a video image on a display device, said video image being discernable in a plurality of objects, and said display device having a minimum surface area for objects, said apparatus comprising:
a video image processor (34) for displaying a video image on a display screen (10) of a display device, said video image having discernable objects (50, 52, 54, 56) each comprising a plurality of pixels;
means (34) for discerning the objects (50, 52, 54, 56) in said video image;
means (28, 34) for zooming said video image by reducing the area of any spaces (58) in the video image not included in said discernable objects (50, 52, 54, 56), and increasing the sizes of said discerned objects (50, 52, 54, 56) until said discerned objects have said minimum surface area, and for generating a status signal;
means for discontinuing said zooming upon receipt of said status signal;
means for detecting the user's selection (54) out of said discerned objects (50, 52, 54, 56); and
means for continuing zooming only on the selected discerned object (54).

8. The apparatus as claimed in claim 7, wherein said apparatus further comprises:
means for removing, from the video image, the discerned objects (50, 52, 56) other than said selected discerned object (54) in response to said detecting means detecting the user's selection.

9. The apparatus as claimed in claim 7, wherein said zooming means (28, 34) increases the size of each of the discerned objects (50, 52, 54, 56) until the size of the relevant discerned object reaches said minimum surface area.

10. The apparatus as claimed in claim 7, wherein said video image is encoded in an XML or HTML object based format.

11. The apparatus as claimed in claim 7, wherein said detecting means highlights said selected discerned object (54).

12. The method as claimed in claim 7, wherein said display device (10) is a 3-D virtual touch display device, and said zooming means detects (22, 24, 26) the position and distance (Z) of a user's finger (42) on and from a display surface (10) of the display device.
